(19) United States
(12) Patent Application Publication
(10) Pub. No.: US 2004/0047017 A1
(43) Pub. Date: Mar. 11, 2004

(54) Scanning beam separation optical system for optical scanning device

(75) Inventors: Mitsuhiro Ohno, Saitama (JP); Hiromitsu Yamakawa, Saitama (JP)

Correspondence Address: YOUNG & THOMPSON, 745 SOUTH 23RD STREET 2ND FLOOR, ARLINGTON, VA, 22202

(73) Assignee: FUJI PHOTO OPTICAL CO., LTD., SAITAMA (JP)

(21) Appl. No.: 10/355,057

(22) Filed: Jan. 31, 2003

Related U.S. Application Data
(63) Continuation of application No. 09/819,809, filed on Mar. 29, 2001, now abandoned.

(30) Foreign Application Priority Data
Mar. 29, 2000 (JP) 2000-091580

(51) Int. Cl. G02B 26/08

(52) U.S. Cl. 359/204

(57) ABSTRACT

An optical scanning device of a type having a scanning optical system for deflecting scanning beams bearing image information of a common subject image which includes a polygon deflection mirror and an f θ lens comprises a scanning beam separation polygon mirror for separating the scanning beams in different directions and a couple of first and second reflection mirrors provided for each scanning beam, the first and second reflection mirrors for at least one of the scanning beams being disposed on opposite sides of the scanning beam separation polygon mirror, respectively so that the scanning beam travels across an axis of the scanning optical system with an effect of providing a long optical path.

### BACKGROUND OF THE INVENTION

1. Field of the Invention

The present invention relates to a scanning beam separation optical system for an optical scanning device suitable for an image forming machine of a type having image carriers such as photosensitive drums which are scanned with scanning beams of light, such as laser beams, so as to form electrostatic latent images identical or different in color thereon, respectively, and transfers the electrostatic latent images as toner images onto a moving printing medium such as a printing paper in order, and, more particularly, to an optical scanning device which is provided with a scanning beam separation optical system for separating the scanning beams from a light source and directing them in different directions toward the image carriers.

2. Description of the Related Art

There have been well known variety of tandem type image forming machines as a color copying machine and a color printer. Such a tandem type color image forming machine is equipped with a plurality of photosensitive drums disposed side by side. The photosensitive drums are exposed to scanning beams, respectively, for scan so as to form electrostatic latent image thereon. The electrostatic latent images on the photosensitive drums are developed as toner images and then transferred one after another to a printing medium such as a printing paper while the printing medium moves in a direction in which the photosensitive drums are arranged side by side, so as thereby to be printed as an entire color image on the printing medium.

The tandem type color image forming machine is typically equipped with four laser sources for producing four color image information, namely yellow (Y) image information, magenta (M) image information, cyan (C) image information and black (BK) image information and four scanning optical systems, one for each photosensitive drum, through which scanning beams emanating from the laser sources are directed to the photosensitive drums to scam them, respectively, so as to form Y, M, C and BK electrostatic latent images on the photosensitive drums. One of the tandem type color image forming machines is known from, for example, Japanese Unexamined Patent Publication No. 11-295625.

Because this type of color image forming machine is equipped with a plurality of scanning optical systems one for each of a plurality of photosensitive drums, it is hard for the color image forming machine to be miniaturized and to be produced at low costs. As disclosed in, for example, Japanese Unexamined Patent Publications Nos. 6-286226, 10-20608 and 10-133131, color image forming machines are equipped with a single scanning optical system commonly used to a plurality of photosensitive drums. The scanning optical system of such a color image forming machine includes an optical deflection element and a scanning beam separation element. The optical deflection element deflects scanning beams from laser sources of the same number as photosensitive drums employed in the color image forming machine commonly to the scanning beam separation element. The scanning beam separation element separates the four scanning beams so as to direct them separately to the photosensitive drums, respectively.

Before describing the present invention in detail, reference is made to FIGS. 3-5 for the purpose of providing a brief background in connection with a prior art optical scanning device that will enhance understanding of the optical scanning device of the present invention.

FIGS. 3 and 4 schematically show an optical scanning device of a conventional tandem type color image forming machine. As shown in FIG. 4, the optical scanning device includes a laser source 1 such as a semiconductor laser array which generates four scanning beams of laser. The scanning beams emanating from the laser source 1 are collimated by a collimating lens 2 and a cylindrical lens 4. Each scanning beam is reflected by a first plane mirror 3 and a second plane mirror 4 so as to impinge on one of reflective facets 6a of an equilateral polygon mirror 6 as scanning beam deflection means which rotates at a fixed speed of rotation. The scanning beam after reflection by the reflective facet 6a of the polygon mirror 6 travels to a stationary inequilateral polygon mirror 8 forming a part of a scanning beam separation optical system passing through an fθ lens system 7. The four parallel scanning beams impinge on the polygon mirror 8 and are separated by the polygon mirror 8 so as to travel in four different directions in which first to fourth cylindrical mirrors 11-14 are disposed, respectively, as shown in FIG. 3. The scanning beams are reflected by the first to fourth cylindrical mirrors 11-14, respectively, and impinge on four photosensitive drums at image forming positions 10, respectively, so as thereby to form Y, M, C and BL electrostatic latent images on the photosensitive drums rotating at a fixed same speed of rotation, respectively. Specifically, because each photosensitive drum continuously rotates about an axis of rotation perpendicular to an axis of rotation Y of the polygon mirror 6, the scanning beam continuously moves back and forth along a straight line on the photosensitive drum in a direction in parallel with the axis of rotation of the photosensitive drum in synchronism with rotation of the polygon mirror 6, so as to scan lines on the photosensitive drum in the direction parallel with the axis of rotation of the photosensitive drum. The direction in parallel with the axis of rotation of the photosensitive drum is hereafter named a primary scanning direction. On the other hand, although the scanning beam itself is fixed in position in a direction in parallel with the axis of rotation Y of the polygon mirror 6, in other word, in a direction perpendicular to the axis of rotation of the photosensitive drum, the scanning beam continuously shifts in position relative to the photosensitive drum in synchronism with rotation of the photosensitive drum in the direction perpendicular to the axis of rotation of the photosensitive drum. The direction perpendicular to the axis of rotation of the photosensitive drum is hereafter named a secondary scanning direction.

As shown in FIG. 5, the polygon mirror 8 has four reflective facets 8a-8d at different angles with respect to an optical axis of the optical scanning system, in particular, the fθ lens system 7. The scanning beams impinge at different incident angles on the reflective facets 8a-8d, respectively, and then are reflected in different directions according to the incident angles. The polygon mirror 8 is formed as a one piece comprising two sections, namely a lower mirror section 9a having a generally trapezoidal section and an upper mirror section 9b having a generally isosceles triangular section. In this instance, the upper mirror section 9b has equilateral side surfaces forming the reflective facets 8b and 8c each of which has an optical axis intersecting the optical axis X of the fθ lens system 7 at an angle smaller than angle at which the optical axis of each of equilateral side surfaces of the lower mirror section 9a forming the reflective facets 8a and 8d intersects the optical axis X of the fθ lens system 7. The scanning beams reflected by the reflective facets 8a and 8d and the scanning beams reflected by the reflective facets 8b and 8c are symmetrical in position with respect to the optical axis X of the fθ lens system 7, respectively The first to fourth cylindrical mirrors 11 to 14 are located in the optical axes of the equilateral side reflective facets 8a-8d, respectively. Specifically, the first and fourth cylindrical mirrors 11 and 14 are symmetrical in position with respective to the optical axis X of the fθ lens system 7. Similarly, the second and third cylindrical mirrors 12 and 13 are symmetrical in position with respective to the optical axis X of the fθ lens system 7. Further, the first to fourth cylindrical mirrors 11 to 14 are so located as to provide optical paths for the scanning beams between the laser source 1 and the image forming position 10 on the photosensitive drums with optical path lengths, respectively, which are equal to one another.

The optical scanning device is additionally provided with a scanning beam detector comprising a plane mirror 15 and a photo sensor 16. The plane mirror 15 is located near an extreme end from which a scan commences in the primary scanning direction so as to reflect the scanning beam from the polygon mirror 6. The photo sensor 16 is located so as to receive the scanning beam reflected by the plane mirror 15. The photo sensor 16 provides a control signal for commencing a scan at a timing of receiving the scanning beam from the plane mirror 15.

It is typical to miniaturize the color image forming machine by installing an optical scanning device which employs a common optical scanning system including the polygon mirror 8 as a scanning beam separation optical system for separating and a plurality of scanning beams in different directions and directing them toward image carriers, respectively. Because the polygon mirror 8 has four reflective facets 8a-8d, there are various restraints on the optical scanning device. That is, while the polygon mirror 8 has reflective facets 8a-8d at different angles with respect to the optical axis X of the fθ lens system 7, the polygon mirror 8 reflects the scanning beams so that the scanning beams travels equal optical path lengths. Therefore, as shown in FIG. 3, the second and third cylindrical mirrors 12 and 13 are disposed closer to the optical axis X of the fθ lens system 7 than the first and fourth cylindrical mirrors 11 and 14, respectively. This forces the optical scanning device to have a large space for the cylinder mirrors 12 and 13 between the polygon mirror 8 and the fθ lens system 7, as a result of which, the optical scanning device has to have a long distance between the fθ lens system 7 and the polygon mirror 8. This leads to a large size of the image forming machine due to a large space for the scanning beam separation optical system of the optical scanning device. In addition, the polygon mirror 6 before the fθ lens system 7 is necessarily disposed near the laser source 1. This causes the problem that vibrations generating from a motor for driving the polygon mirror 6 are transmitted to the laser source 1 and, in consequence, have an adverse influence on the stability of laser beams. In order to avoid the influence of vibrations on the stability of laser beams, it is necessary for the optical scanning device to support the laser source 1 by a vibration isolation structure, which is complicated in structure, incorporated in support means such as a bracket for supporting the laser source and/or the motor.

The arrangement of the cylindrical mirrors in which the respective scanning beams have different optical path lengths to the image forming positions 10, respectively. Therefore, there is a possibility of making it uncertain to focus the scanning beams as spots identical in diameter with one another on the photosensitive drums. This leads to geometrically inconsistency of electrostatic latent images on the photosensitive drums with one another, and hence, to an unclear image that is developed from the electrostatic latent image.

### SUMMARY OF THE INVENTION

It is therefore an object of the present invention to provide a scanning beam separation optical system suitable for an optical scanning device which is miniaturized by locating an fθ lens system at a small distance from a location where the scanning beam separation means of the scanning beam separation optical system is installed and accordingly has a small space available for installing the scanning beam separation optical system.

It is another object of the present invention to provide a scanning beam separation optical system for an optical scanning device, which enables substantially equalizing optical path from reflection means of the scanning beam separation optical system for adjusting beam spots in size to photosensitive carriers such as photosensitive drums on which the beam spots are formed, respectively, to one another so as thereby to form electrostatic latent images geometrically identical with one another on the photosensitive drums.

The aforesaid objects of the present invention are accomplished by a scanning beam separation optical system, that is installed to an optical scanning device comprising reflective deflection means such as a polygon mirror for reflecting and deflecting a plurality of scanning beams of light in parallel with one another, for reflecting and separating the scanning beams of light reflected and deflected by the reflective deflection means in different directions, respectively, so as to scan given scanning areas of a plurality of image carrying means, respectively, in a direction in which the reflective deflection means deflects the scanning beans of light. The scanning beam separation optical system comprises a polygon separation mirror, for example a mirror quadrilateral in cross-section, for reflecting the scanning beams impinging thereon in parallel with one another in opposite directions with respect to the polygon separation mirror of the scanning beam separation optical system, first reflection means provided one for each the scanning beam, the first reflection means reflecting the scanning beam incident thereon so as to direct the scanning beam in a specified direction, and second reflection means provided one for each the scanning beam, the second reflection means receiving and reflecting the scanning beam reflected in the specified direction by the first reflection means so as to direct the scanning beam of light in a specified direction. At least one couple of the first reflection means and the second reflection means for the scanning beams are located on opposite side of the polygon separation mirror of the scanning beam separation optical system so to provide an optical path that extends spatially across the polygon separation mirror of the scanning beam separation optical system.

The scanning beam reflected by the polygon separation mirror is reflected by the first reflection means and successively by the second reflection means. The scanning beam reflected by the first reflection means travels spatially crossing the polygon separation mirror and impinges on the second reflection means. As this arrangement of the scanning beam separation optical system provides an optical path longer as compared with the conventional scanning beam separation optical system in which first and second reflection means are located on the same side of a polygon separation mirror, the second reflection means can be located in a position close to the polygon separation mirror, so that the fθ lens system is located at a short distance to the polygon separation mirror with an effect of reducing a space for installation of the scanning beam separation optical system.

The scanning beam separation optical system may comprises the first reflection means and the second reflection means located on opposite sides of the polygon separation mirror for at least one of the scanning beams so as to form partly the optical path of the scanning beam.

In an preferred embodiment of the scanning beam separation optical system, the polygon separation mirror separates four scanning beams incident thereupon into two groups, each consisting of two scanning beams in parallel with each other, and directs them toward opposite sides of the polygon separation mirror. The couple of first reflection means for each of the two groups of the scanning beams are located in different positions in a direction in which the scanning beams of one of the group travel, and the couples of first reflection means for the two groups of the scanning beams are symmetrical in position with respect to the polygon separation mirror. The first reflection means for one of each of the tow groups which is closer to the polygon separation mirror than that for the group and the second reflection mirror which receives the scanning beam reflected by the first reflection means located closer to the polygon separation mirror are put so as to form a light path crossing the scanning beams incident upon the polygon separation mirror.

In the color image forming machine, four scanning beams generally are used to bear Y, M, C and BK image information as described previously. According to the scanning beam separation optical system, the optical paths for two inside scanning beams than two outside scanning beams. This arrangement makes it easy to adjust the optical paths for the inside scanning beams approximately equal to the optical paths for the outside scanning beans and further to adjust all of the optical paths from the second reflection means to the image carrying means such as photosensitive drums for all of the scanning beams approximately equal to one another. Therefore, it is enabled to form scanning beam spots identical in diameter with one another on the image carrying means, so that electrostatic latent images on the image carrying means are geometrically identical with one another. As a result, an image transferred to a recording paper is sharp and clear.

The second reflection means may comprise a cylindrical mirror. The cylindrical mirrors are located in position for reflecting and directing the scanning beam reflected by the first reflection mirror to the image carrying means so that optical paths between the second reflection means and the image carrying means for all of the scanning beams are substantially equal to one another. The cylindrical mirrors employed as the second reflection means enables adjusting of the scanning beams in diameter for successive processes.

### BRIEF DESCRIPTION OF THE DRAWINGS

The above and other objects and features of the present invention will be clearly understood from the following description with respect to the preferred embodiments thereof when considered in conjunction with the accompanying drawings, in which:

FIG. 1 is a schematic diagrammatic side view of an optical scanning device capable of detecting commencement of a scan in accordance with a preferred embodiment of the present invention that is installed to an image forming machine by way of example;

FIG. 2 is a front view of the optical scanning device shown in FIG. 1;

FIG. 3 is a schematic diagrammatic side view of a prior art optical scanning device capable of detecting commencement of a scan that is installed to an image forming machine;

FIG. 4 is a front view of the prior art optical scanning device shown in FIG. 3;

FIG. 5 is an explanatory view showing a scanning beam separation element of the prior art optical scanning device; and

FIG. 6 is an explanatory view showing a difference between deflection angles of a scanning beam according to locations of a mirror of a scanning beam detector of an optical scanning device.

### DETAILED DESCRIPTION OF THE PREFERRED EMBODIMENT

Parts which are not direct importance to the invention and parts which are purely of conventional construction will not be described in detail since their construction and operation can easily be arrived at by those skilled in the art.

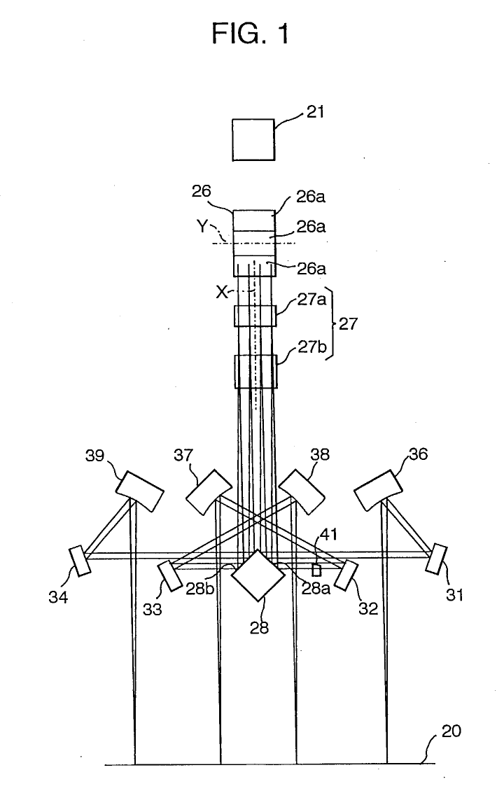

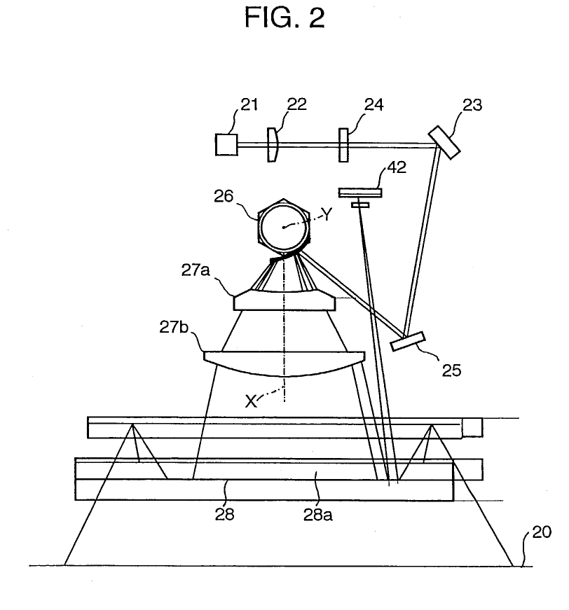

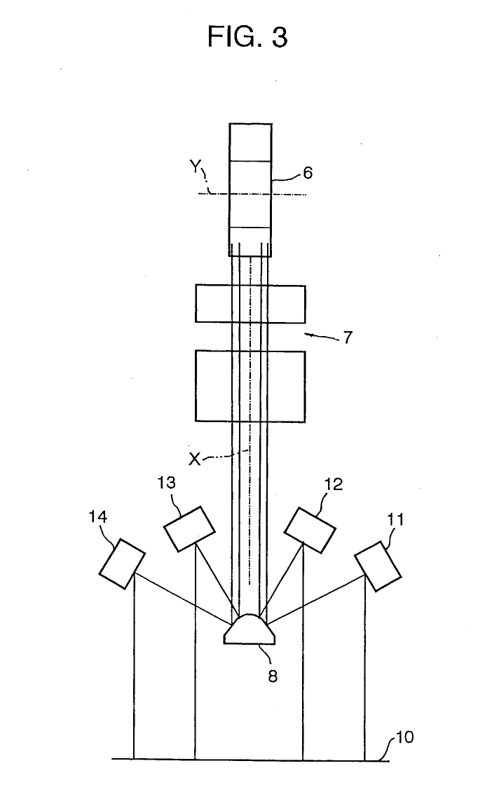

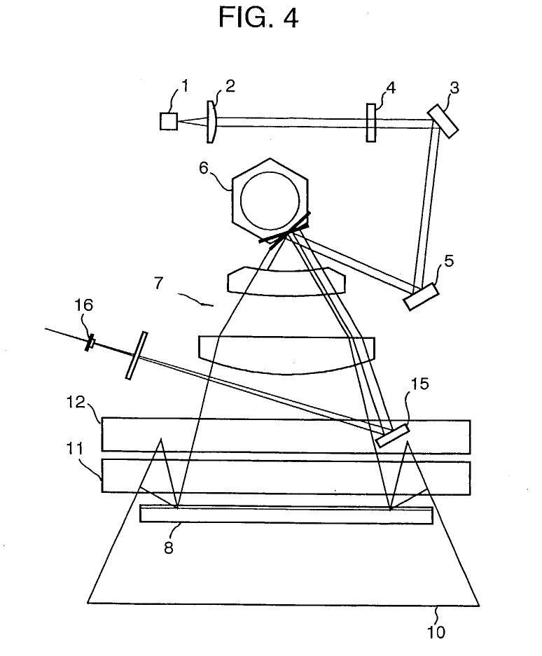

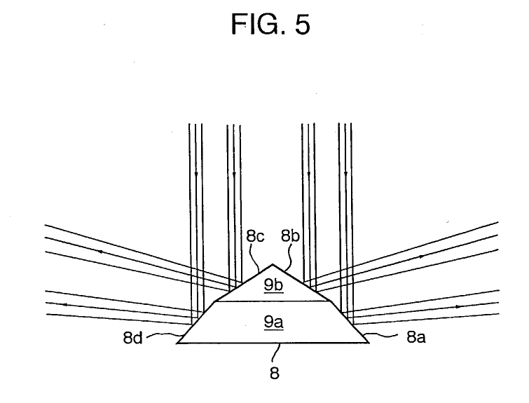

Referring to the drawings in detail, and, in particular, to FIGS. 1 and 2 showing an optical scanning device equipped with a scanning beam separation optical system in accordance with a preferred embodiment of the present invention, the optical scanning device includes a laser source 21 such as, for example, a semi-conductor laser array, which generates four parallel scanning beams of laser. The scanning beams bear image information, namely yellow (Y) image information, magenta (M) image information, yellow (Y) image information and black (BL) image information, respectively. The scanning beams emanating from the laser source 21 are collimated by a collimating lens 22 and a cylindrical lens 24. Each scanning beam is reflected by a first plane mirror 23 and a second plane mirror 24 in order so as to impinge on one of reflective facets 26a of an equilateral polygon deflection mirror 26, for example a mirror hexagonal in section, as a deflection element which rotates at a fixed speed of rotation. The polygon deflection mirror 26 reflects and deflects the scanning beam by the reflective facets 26a successively. The scanning beam passes through an f θ lens system 27 comprising lenses 27a and 27b and then travels to a scanning beam separation optical system. The scanning beam separation optical system 30 comprises a polygon separation mirror 28, specifically a mirror quadrilateral in section, and four couples of plane mirrors 31-34 and cylindrical mirrors 36-49.

The polygon deflection mirror 26, which is of, for example, an equilateral hexagon, has six reflective facets 26a at the respective sides and rotates about an axis of rotation Y The fθ lens system 27 is known in various forms and may take any well known form in the art. The polygon deflection mirror 26, which is of an equilateral quadrangle, has two reflective facets 28a and 28b, each reflective facet 28a, 28b being in a plane including one of adjacent sides of the quadrangle and parallel with to axis of rotation of the polygon deflection mirror 26. The polygon separation mirror 28 at adjacent sides other than the reflective facets 28a and 28b may be finished preferably for stable installation thereof to the optical scanning device. The polygon separation mirror 28 is positioned so as to receive the four scanning beams, two at each side of an edge line along which the adjacent reflective facets 28a and 28b intersect. Each of the reflective facets 28a and 28b is at an angle of 45° with respect to a reference plane which is a plane including the edge line and parallel with the axis X of the fθ lens system 27 or with the scanning beams incident upon the polygon separation mirror 28.

On opposite sides of the polygon separation mirror 28 there are first to fourth plane mirrors 31-34 as first reflection means, two on each side. The plane mirrors 31-34 reflect back the scanning beams incident thereupon, respectively, so as to direct them to cylindrical mirrors 36-39, respectively. Specifically, the first and the fourth plane mirrors 31 and 34 are at the same distances in an axial direction of the fθ lens system 27 and symmetrical in position with respect to the polygon separation mirror 28. Similarly, the second plane mirror 32 and the third plane mirror 33 are at the same distances in a direction of the axis X of the fθ lens system 27 and symmetrical in position with respective to the polygon separation mirror 28. The first plane mirror 31 and the fourth plane mirror 34 are farther away aside from the polygon separation mirror 28 in the primary scanning direction than the second plane mirror 32 and the third plane mirror 33, respectively. Further, the first plane mirror 31 and the fourth plane mirror 34 are closer to the polygon deflection mirror 26 than the second plane mirror 32 and the third plane mirror 33. According to the arrangement of the first to fourth plane mirrors 31-34 relative to the polygon separation mirror 28, the parallel scanning beams impinging on the polygon separation mirror 28 are separated and directed to the plane mirrors 31-34 different in position.

The plane mirrors 31-34 reflect the separate scanning beams and direct them in four different directions, respectively, in which first to fourth cylindrical mirrors 36-39 are located as second reflection means in a substantially straight line in the primary scanning direction and closer to the polygon deflection mirror 26 in the direction of the axis X of the fθ lens system 27, respectively, as shown in FIG. 1. In order for optical paths for the four scanning beams to have optical path lengths between the laser source 1 and the image forming positions 10 on the photosensitive drums, respectively, which are equal to one another, the first to fourth cylindrical mirrors 36-39 are arranged in specific relative positions. Specifically, the first cylindrical mirror 36 and the third cylindrical mirror 38 are located on one side of the polygon separation mirror 28 in the primary scanning direction. The second cylindrical mirror 37 and the fourth cylindrical mirror 38 are located on another side of the polygon separation mirror 28 in the primary scanning direction. Further, the first cylindrical mirror 36 and the fourth cylindrical mirror 38 are farther away aside from the polygon separation mirror 28 in the primary scanning direction than the second cylindrical mirror 37 and the third cylindrical mirror 38, respectively. The cylindrical mirrors 36-39 reflect the scanning beams incident thereupon and direct them to an image carrier (not shown) comprising, for example, four photosensitive drums. That is, the optical path defined by the second plane mirror 32 and the second cylindrical mirror 37 passes obliquely across the axis X of the fθ lens system 27, in other words, spatially across the polygon separation mirror 28.

The respective scanning beams impinge on the four photosensitive drums at image forming positions 20, respectively, and scan the photosensitive drums in the primary and secondary directions, so as thereby to form Y. M, C and BL electrostatic latent images on the photosensitive drums, respectively. The photosensitive drums as image carrier rotate at the same fixed speed of rotation. While the photosensitive drum continuously rotates about an axis of rotation perpendicular to an axis of rotation Y of the polygon deflection mirror 26, the scanning beam continuously moves back and forth along a straight line on the photosensitive drum in synchronism with rotation of the polygon deflection mirror 26, so as to scan lines on the photosensitive drum from one extreme end to an opposite extreme end of a permissible or given scanning area in the primary scanning direction in synchronism with rotation of the polygon deflection mirror 26. Simultaneously, tie scanning beam continuously shifts in position relative to the photosensitive drum in the secondary scanning direction in synchronism with rotation of the photosensitive drum.

The optical scanning device is additionally provided with a scanning beam detector comprising a plane mirror 41 (see FIG. 1) which is disposed near the polygon separation mirror 28 and a photo sensor 42 (see FIG. 2) which is disposed near the polygon deflection mirror 26. The plane mirror 41 is located in an optical path of one of the scanning beams which is separated from the other three and directed to, for example, the plane mirror 32. Specifically, the plane mirror 41 receives the scanning beam immediately before it services to a scan. In this sense, the scanning beam impinges on the plane mirror 41 is called an unconcerned scanning beam in this specification The plane mirror 41 reflects the unconcerned scanning beam at a certain reflection angle back to the reflective facet 28a of the polygon separation mirror 28. The polygon separation mirror 28 then reflects the unconcerned scanning beam once again and directs it to the photo sensor 42. The photo sensor 42 can be adjusted in position in the direction in which the polygon deflection mirror 26 deflects the unconcerned scanning beam impinging thereon by regulating the reflection angle of the unconcerned scanning beam by the plane mirror 41. The photo sensor 42 provides a control signal for commencing a scan at a timing of receiving the unconcerned scanning beam from the polygon separation mirror 28.

In operation of the optical scanning device equipped with the scanning beam separation optical system thus structured, the four scanning beams emanating from the laser source 21 are collimated by the collimating lens 22 and the cylindrical lens 24. Each scanning beam is reflected by the first plane mirror 23 and the second plane mirror 25 in order so as to be directed to the polygon deflection mirror 26 which is continuously rotating. The polygon deflection mirror 26 reflects the scanning beam impinging on a reflective facet 26a at a reflection angle which continuously varies with time. As a result, the scanning beam is deflected from one of the opposite extreme ends to another extreme end of the given scanning angle θ in the primary scanning direction. In other words, the scanning beam continuously shifts its incident position on the fθ lens system 27 according to a rotational angle of the polygon deflection mirror 26. The scanning beam passes through the fθ lens system 27 and then impinges on one of the facet 28a of the stationary polygon separation mirror 28 at a position which continuously shifts from one of opposite ends to another end. At this time, the four scanning beams are substantially parallel with one another and divided into two groups. One group of two scanning beams impinge on one of the reflective facets 28a and 28b intersecting at a right angle. Another group of two scanning beams impinge on another of the reflective facets. The two groups of scanning beams are almost symmetrical in incident position with respect to the reference plane.

At the early stage of deflection of the scanning beam by the polygon deflection mirror 26, an unconcerned scanning beam impinges on the facet 28a polygon separation mirror 28 and is reflected by the facet 28a of the polygon separation mirror 28. The unconcerned scanning beam impinges on the plane mirror 41 of the scanning beam detector and is then reflected back to the polygon separation mirror 28 by the plane mirror 41 of the scanning beam detector. The unconcerned scanning beam reflected by the facet 28a of the polygon separation mirror 28 impinges on the facet 28a of the polygon separation mirror 28 and is reflected again by the facet 28a of the polygon separation mirror 28. The scanning beam then travels to the photo sensor 42 of the scanning beam detector. When the photo sensor 42 receives the unconcerned scanning beam from polygon separation mirror 28, it provides a signal for commencement of a scan.

Two parallel scanning beam impinges on each facet 28a, 28b of the polygon separation mirror 28 at different incident positions, respectively. Because of an intersecting angle of 45 of the reflective surface of the facet 28, 28b of the polygon separation mirror 28 with respect to the reference plane, the respective two scanning beams are reflected to turn at an angle of 90 with respect to the reference plane, so as to travel to the plane mirrors 31 and 32, or 33 and 34, still in parallel with each other. The scanning beam reflected by the first plane mirror 31 travels to the first cylindrical mirror 36 disposed comparatively farther away from the optical axis X of the fθ lens system 27 but comparatively closer to the first plane mirror 31. The scanning beam reflected by the second plane mirror 32 travels, crossing the optical axis X of the fθ lens system 27, to the second cylindrical mirror 37 disposed comparatively closer to the optical axis X of the fθ lens system 27. Similarly, the scanning beam reflected by the third plane mirror 33 travels, crossing the optical axis X of the f θ lens system 27, to the third cylindrical mirror 38 disposed comparatively closer to the optical axis X of the fθ lens system 27. The scanning beam reflected by the fourth plane mirror 34 travels to the fourth cylindrical mirror 39 disposed comparatively farther away from the optical axis X of the fθ lens system 27 but comparatively closer to the fourth plane mirror 34. As a result, the scanning beams are separately focused on the photosensitive drums in the image forming positions 20 at appropriate intervals.

Because the second cylindrical mirror 37 and the third cylindrical mirror 38 are disposed in position opposite to the second plane mirror 32 and the third plane mirror 33 with respect to the polygon separation mirror 28 or the optical axis X of the fθ lens system 27, although the second plane mirror 32 and the third plane mirror 33 are at comparatively short distances from the polygon separation mirror 28, the optical path lengths to the second cylindrical mirror 37 and the third cylindrical mirror 38 from the polygon separation mirror 28, respectively, can be as sufficiently long as required. In consequence, the path lengths for the scanning beams between the polygon deflection mirror 26 and the image forming positions 20 can be substantially equal to one another. This makes it certain to focus the scanning beams as spots identical in diameter with one another on the photosensitive drums. Accordingly, electrostatic latent images on the photosensitive drums are geometrically identical with one another.

Although the present invention has been described in connection with, by way of example, the optical scanning device equipped with a scanning beam separation optical system for separating four scanning beams from one another in different directions, it may be embodied in an optical scanning device which uses more than two scanning beams. In the case where an even number of scanning beams are used, it is preferred to separate the scanning beams into two groups of even numbers of scanning beams in opposite directions with respect to the scanning beam separation mirror.

According to the scanning beam separation optical system for an optical scanning device in which the first reflection means and the second reflection means are located on opposite sides of the scanning beam separation mirror, the optical path between the first reflection means and the second reflection means can be made longer than that of the conventional scanning beam separation optical system in which the first and second reflection means are located on the same side of the scanning beam separation means. This an arrangement avoids the necessity of shifting the location of installation of reflection means toward the fθ lens system in order to secure the optical path lengths for the scanning beans, so as thereby to make a distance between the scanning beam separation means and the fθ lens system. As a result, the scanning beam separation optical system is installed to optical scanning devices which have only a small available space. Therefore, such an optical scanning device, and an image forming machine equipped with the optical scanning device, can be miniaturized in overall size.

It is to be understood that although the present invention has been described with regard to a preferred embodiment thereof, various other embodiments and variants may occur to those skilled in the art, which are within the scope and spirit of the invention, and such other embodiments and variants are intended to be covered by the following claims.

What is claimed is:

1. A scanning bean separation optical system for an optical scanning device which comprises reflective deflection means for reflecting and deflecting a plurality of scanning beams of light in parallel with one another for reflecting and separating said scanning beams of light reflected and deflected by said reflective deflection means in different directions, respectively, so as to scan given scanning areas of a plurality of image carrying means, respectively, in a direction in which said reflective deflection means deflects said scanning beams of light, said scanning beam separation optical system comprising:
a polygon mirror for reflecting said scanning beams impinging thereon in parallel with one another in opposite directions with respect to said polygon mirror of said scanning beam separation means;
first reflection means provided one for each said scanning beam, said first reflection means reflecting said scanning beam incident thereon so as to direct said scanning beam in a specified direction; and
second reflection means provided one for each said scanning beam, said second reflection means receiving and reflecting said scanning beam reflected in said specified direction by said first reflection means so as to direct said scanning beam of light in a specified direction;
wherein at least one couple of said first reflection means and said second reflection means for said scanning beams are disposed on opposite side of said polygon mirror of said scanning beam separation means so to provide an optical path that extends spatially across said polygon mirror of said scanning beam separation means.

2. A scanning bean separation optical system as defined in claim 2, wherein said first reflection means and said second reflection means on opposite sides of said polygon mirror of said scanning beam separation means forms part of a light path of said scanning beam.

3. A scanning bean separation optical system as defined in claim 2, wherein said polygon mirror of said scanning beam separation means separates four said scanning beams incident thereupon into two groups, each consisting of two said scanning beams in parallel with each other, toward opposite sides of said polygon mirror of said scanning beam separation means, said first reflection means for each of said two groups of said scanning beams are disposed in different positions in a direction in which said scanning beams of each said group travel, and said first reflection means for said two groups of said scanning beams are symmetrical in position with respect to said polygon mirror of said canning beam separation means, said first reflection means for each said group which is closer to said polygon mirror of said scanning beam separation means and said second reflection mirror which receives said scanning beam reflected by said first reflection means disposed closer to said polygon mirror of said scanning beam separation means being dispose so as to form a light path therebetween crossing said scanning beams incident upon said polygon mirror of said scanning beam separation means.

4. A scanning bean separation optical system as defined in claim 1, wherein said second reflection means comprises a cylindrical mirror disposed such as to reflect and direct said scanning beam reflected by said first reflection mirror to said image carrying means so that light paths between said second reflection means and said image carrying means for said scanning beams are substantially equal to one another.
